(19) United States
(12) Patent Application Publication
(10) Pub. No.: US 2013/0160048 A1
(43) Pub. Date: Jun. 20, 2013

(54) SYSTEM AND METHOD OF PROVIDING SIGN LANGUAGE BROADCASTING SERVICE

(71) Applicant: Electronics and Telecommunications Research Institute, Daejeon (KR)

(72) Inventors: Yong Seong CHO, Daejeon (KR); Tae Kyoon KIM, Daejeon (KR); Dong Joon CHOI, Daejeon (KR); Nam Ho HUR, Daejeon (KR)

(73) Assignee: ELECTRONICS AND TELECOMMUNICATIONS RESEARCH INSTITUTE, Daejeon (KR)

(21) Appl. No.: 13/714,583

(22) Filed: Dec. 14, 2012

(30) Foreign Application Priority Data
Dec. 14, 2011 (KR) 10-2011-0134400

(51) Int. Cl. H04N 21/81

(52) U.S. Cl. CPC H04N 21/816
USPC 725/32

(57) ABSTRACT

Provided is a system and method of providing a sign language broadcasting service to viewers having hearing impairments, and more particularly, the system and method of providing a sign language broadcasting service that may enable a user to select an option of viewing only a broadcast image, or an option to viewing both the broadcast image and a sign language interpreting image, by transmitting the broadcast image and the sign language interpreting image using different transport streams.

### CROSS-REFERENCE TO RELATED APPLICATION

This application claims the benefit of Korean Patent Application No. 10-2011-0134400, filed on Dec. 14, 2011, in the Korean Intellectual Property Office, the disclosure of which is incorporated herein by reference.

### BACKGROUND

1. Field of the Invention

The present invention relates to a system and method of providing a sign language broadcasting service to viewers having hearing impairments.

2. Description of the Related Art

A number of countries around the world have enacted laws and regulations prohibiting discrimination against the disabled, promoting rights of the disabled, and the like, in an effort to support the disabled so that a variety of information may be available to the disable through television. A broadcast for the disabled provides subtitles and sign language broadcasts for the hearing-impaired and descriptive video services for the visually impaired. A dual sign language broadcasting service may refer to a broadcasting service with sign language interpretation for the hearing-impaired. The dual sign language broadcasting service is used as an important means that may guarantee equal access broadcast rights for the non-disabled, by providing subtitled broadcasts and convenience for the hearing-impaired in viewing broadcasts.

FIG. 1 is a diagram illustrating a method of providing a sign language broadcasting service according to a conventional art.

Referring to FIG. 1, a separate sign language interpreting image 101 for sign language interpretation may be transmitted along with a broadcast image 100, by inserting the sign language interpreting image 101 on a side of the broadcast image 100. Generally, the sign language interpreting image 101 may refer to an image in which a broadcast program is interpreted using sign language. The sign language interpreting image 101 may be displayed in a circular or rectangular region of a predetermined size, in a corner of the identical broadcast program.

In the conventional method, since a portion of the broadcast image 100 may be obscured by the sign language interpreting image 101, general viewers who do not require the sign language interpretation may experience an inconvenience. In order to alleviate such an inconvenience, a size of the sign language interpreting image 101 may be reduced. In this instance, however, the hearing-impaired may be faced with a difficulty in viewing a face or a gesture of a sign language interpreter, through the sign language interpreting image 101 of which the size is reduced.

Recently, broadcasting services have been transmitted to a television installed in each house, and various portable terminals, for example, a digital multimedia broadcasting (DMB) terminal, a smart phone, a tablet personal computer (PC), and the like. However, sizes of most portable terminals are even smaller than a size of a television. In addition, when a conventional sign language broadcasting service is provided to such portable terminals, the inconvenience described above may be increased.

### SUMMARY

An aspect of the present invention provides a system and method of providing a sign language broadcasting service that may enable a user to select an option of viewing only a broadcast image, or an option of viewing both the broadcast image and a sign language interpreting image, by transmitting the broadcast image and the sign language interpreting image using different transport streams.

According to an aspect of the present invention, there is provided a method of providing a sign language broadcasting service, the method including encoding a broadcast image of a broadcast program in a form of a transport stream, encoding a sign language interpreting image in a form of a transport stream, multiplexing the encoded broadcast image and the encoded sign language interpreting image into a single program transport stream, and transmitting image data resulting from the multiplexing to a broadcast receiver.

In this instance, the broadcast image and the sign language interpreting image may be encoded in a moving picture experts group (MPEG) transport stream.

The method may further include incorporating information related to the sign language interpreting image in the image data resulting from the multiplexing.

The incorporating may include incorporating information indicating whether a sign language interpreting image is present, and a sign language descriptor in the image data resulting from the multiplexing.

The sign language descriptor may include identification information of a packet in which a sign language image is included.

The information indicating whether a sign language interpreting image is present, and the sign language descriptor may be present as information inserted in a program map table (PMT) syntax.

According to another aspect of the present invention, there is also provided a method of receiving a sign language broadcasting service, the method including receiving streaming data from a digital broadcast headend system, verifying program designation information from the received streaming data, determining whether a sign language interpreting image is present in the streaming data, based on the verified program designation information, filtering a main broadcast image and a sign language interpreting image from the streaming data, respectively, when the sign language interpreting image is present as a result of the determining, and composing the filtered main broadcast image and the filtered sign language interpreting image into a single image, and displaying the single image.

In this instance, the determining may include interpreting a program allocation table (PAT) syntax and a PMT syntax from the streaming data, and obtaining information about a sign language interpreting image based on a result of the interpreting, and determining whether a sign language interpreting image is present in the streaming data, based on the obtained information about the sign language interpreting image.

The information related to the sign language interpreting image may include information indicating whether the sign language interpreting image is present, and a sign language descriptor.

According to still another aspect of the present invention, there is also provided a sign language broadcast service system, including a digital broadcast headend system to encode each of a broadcast image of a broadcast program and a sign language interpreting image in a form of a transport stream, to multiplex the encoded broadcast image and the encoded sign language interpreting image into a single program transport stream, and to transmit image data resulting from the multiplexing to a broadcast receiver, and a broadcast receiver to receive streaming data from the digital broadcast headend system, to determine whether a sign language interpreting image is present in the streaming data, based on program designation information verified from the received streaming data, to filter a main broadcast image and the sign language interpreting image from the streaming data, respectively, when the sign language interpreting image is present as a result of the determining, and to compose the filtered main broadcast image and the filtered sign language interpreting image into a single image, and display the single image.

According to embodiments of the present invention, a user may selectively use a mode for viewing only a broadcast image and a mode for viewing both the broadcast image and a sign language interpreting image each time.

According to embodiments of the present invention, a viewer having hearing impairments may freely adjust a size and a location of a sign language interpreting image to be displayed in a broadcast image.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a method of providing a sign language broadcasting service according to a conventional art;

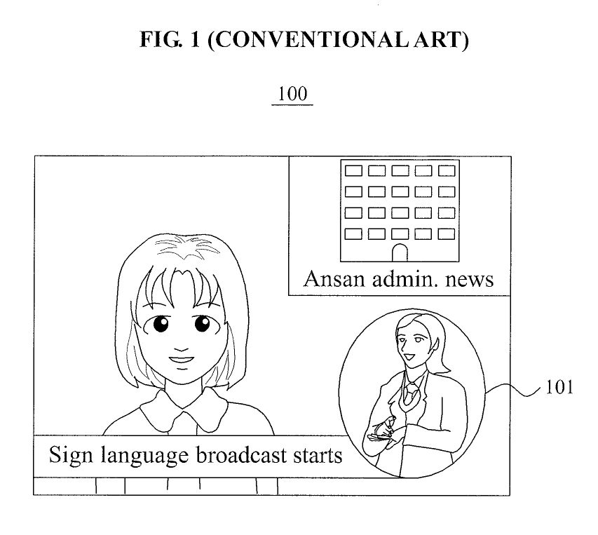

FIG. 2 is a diagram illustrating a digital broadcast headend system for applying a method of providing a sign language broadcasting service according to an embodiment of the present invention;

FIG. 3 is a diagram illustrating a program allocation table (PAT) syntax and a program map table (PMT) syntax provided by the digital broadcast headend system of FIG. 2;

FIG. 4 is a table illustrating an example of a sign language descriptor of FIG. 3;

FIG. 5 is a flowchart illustrating a process of a broadcast receiver selectively displaying a sign language interpreting service in a method of providing the sign language interpreting service according to an embodiment of the present invention; and

FIG. 6 is a flowchart illustrating an operation of a broadcast receiver in a method of providing the sign language interpreting service according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

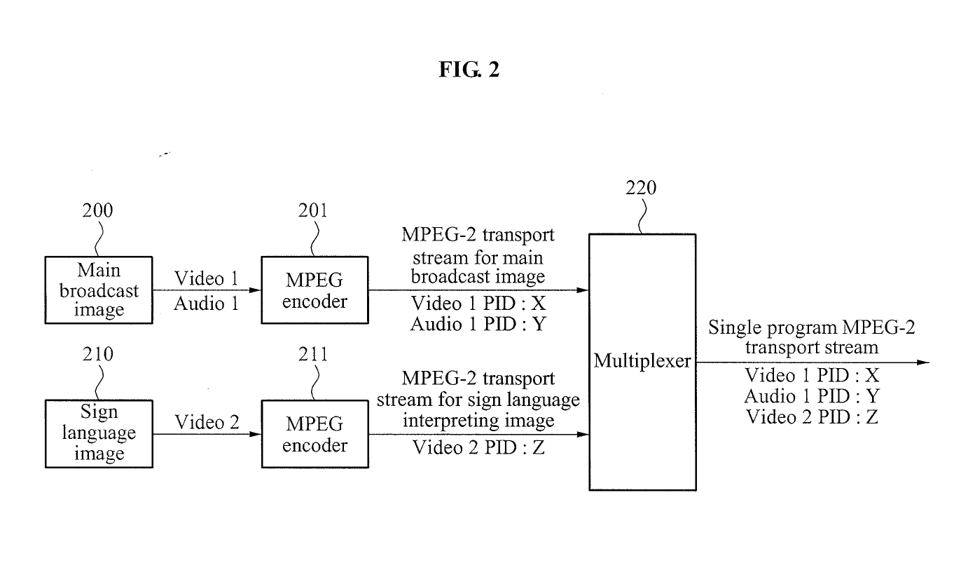

FIG. 2 is a diagram illustrating a digital broadcast headend system for applying a method of providing a sign language broadcasting service according to an embodiment of the present invention.

Referring to FIG. 2, the digital broadcast headend system may receive a main broadcast image 200 of a main broadcast program, and a sign language interpreting image 210 corresponding to the main broadcast image 200, respectively, and may output a single transport stream.

The digital broadcast headend system may include a first moving picture experts group (MPEG) encoder 201, a second MPEG encoder 211, and a multiplexer 220.

The first MPEG encoder 201 may receive the main broadcast image 200 of the main broadcast program that is mainly displayed for all viewers. The second MPEG encoder 211 may receive the sign language interpreting image 210 that is provided for a hearing impaired viewer. The first MPEG encoder 201 and the second MPEG encoder 202 are provided as examples, and may encode video data, audio data, or the like which is input according to the ISO/IEC 13818-1 MPEG-2 System standard, that is, each of the main broadcast image 200 and the sign language interpreting image 210, in a form of an MPEG-2 transport stream.

The main broadcast image 200 may include video data Video 1, and audio data Audio 1, and the sign language interpreting image 210 may include video data Video 2. The first MPEG encoder 201 may encode the video data Video 1 in a form of an MPEG transport stream, and may set identification information indicating the video data Video 1 of the main broadcast image 200, for example, set a packet identification (PID) value of the video data Video 1 to X. The first MPEG encoder 201 may also encode the audio data Audio 1 in a form of an MPEG transport stream, and may set identification information indicating the audio data Audio 1 of the main broadcast image 200, for example, set a PID value of the audio data Audio 1 to Y. Similarly, the second MPEG encoder 211 may encode the video data Video 2 in a form of an MPEG transport stream, and may set identification information indicating the video data Video 2 of the sign language interpreting image 210, for example, set a PID value of the video data Video 2 to Z.

The transport streams output from the first MPEG encoder 201 and the second MPEG encoder 211 may be transferred to the multiplexer 220. The multiplexer 220, as an MPEG multiplexer, may multiplex the plurality of input transport streams into a single program transport stream, and output the single program transport stream. Accordingly, the output single program transport stream may be multiplexed from the transport streams encoded from the video data Video 1 of the main broadcast image 200, the audio data Audio 1 of the main broadcast image 200, and the video data Video 2 of the sign language interpreting image 210. The digital broadcast headend system may transfer a result of the multiplexing to a broadcast receiver. Further, the digital broadcast headend system may transmit information related to the sign language interpreting image 210, for example, identification information, using program specific information (PSI) or program map table (PMT) of service information (SI).

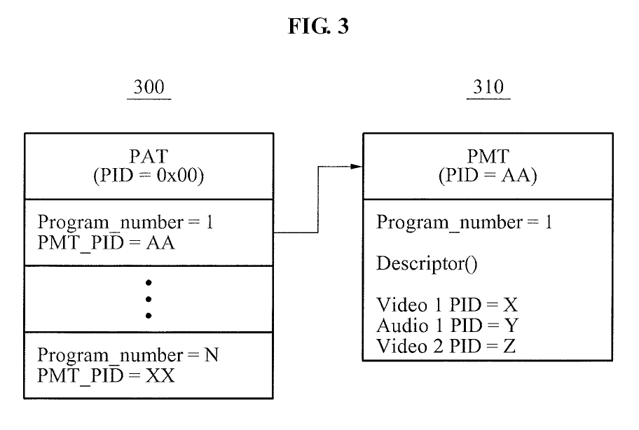

FIG. 3 is a diagram illustrating a PAT syntax and a PMT syntax provided by the digital broadcast headend system of FIG. 2. In a typical digital broadcast, a PAT, a PMT, and the like may be multiplexed along with a broadcast stream, whereby the broadcast stream may be transmitted along with information about a current channel, and information about programs for each channel.

Referring to FIG. 3, the PAT syntax may provide a correlation between an identification number of each program to be transmitted through the current channel, and a packet PID of a transport stream to be used for transmitting) a PMT describing components of each program. In addition, the PMT syntax may describe an identification number of each program, PID information of a packet by which an individual stream, for example, a video, audio, and the like that constitute a program, may be transmitted, and PID information of a program clock reference (PCR) packet.

The PAT syntax may describe identification information of a broadcast program, for example, Program_number=1, and identification information of a packet of a PMT, for example, PMT_PID=AA. The PMT syntax may be designated along with the program identification information of the PAT syntax, for example, Program_number=1. Accordingly, the PMT syntax may include the program identification information of the PAT syntax, for example, Program_number=1, and information related to a sign language interpreting image. The information related to the sign language interpreting image may describe a sign language descriptor that is newly defined, for example, sign_language_descriptor, and identification information for each data, for example, a main image video PID=X, a main image audio PID=Y, and a sign language interpreting image video PID=Z.

A broadcast receiver may receive a transport stream, a PAT syntax, and a PMT syntax from the digital broadcast headend system, and may identify a relationship between a main broadcast image and a sign language interpreting image constituting a broadcast program, based on the received PAT syntax and the received PMT syntax.

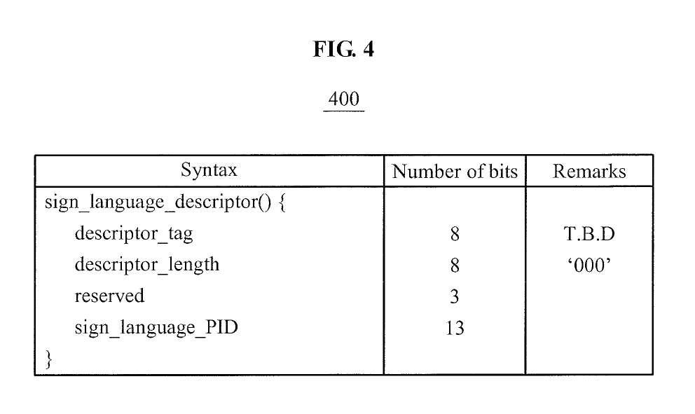

FIG. 4 is a table illustrating an example of the sign language descriptor of FIG. 3.

Referring to FIG. 4, in the sign language descriptor, a sign_language_PID field of a 13-bit size may be defined. Identification information of a packet including a sign language interpreting image may be set in the sign_language_PID field. Using the sign_language PID field, the digital broadcast headend system may inform a broadcast receiver of identification information of a packet that transmits the sign language interpreting image. That is, the sign language descriptor may be inserted in a PMT syntax, as described with reference to FIG. 3. Accordingly, the broadcast receiver having received the broadcast program may verify the PMT syntax to verify whether a sign language interpreting image is included in a corresponding program.

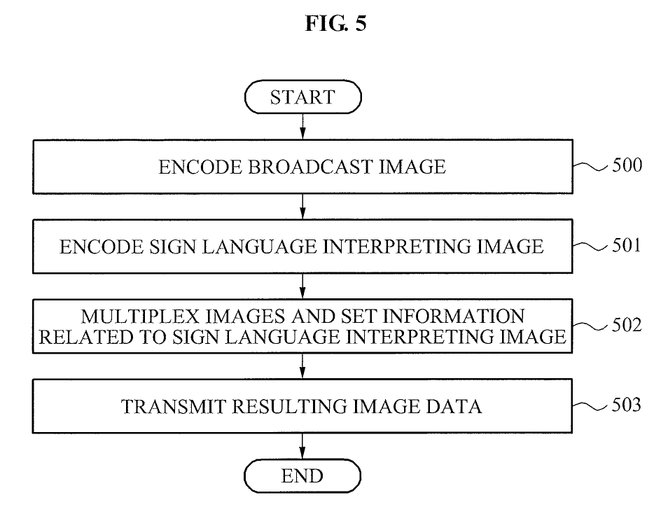

FIG. 5 is a flowchart illustrating a method of providing a sign language interpreting service according to an embodiment of the present invention.

Referring to FIG. 5, in operation 500, a digital broadcast headend system may encode a broadcast image of a broadcast program in a form of a transport stream.

In operation 501, the digital broadcast headend system may encode a sign language interpretation of the broadcast program in a form of a transport stream.

Here, the broadcast image and the sign language interpreting image may be encoded in a form of an MPEG transport stream.

In operation 502, the digital broadcast headend system may multiplex the broadcast image and the sign language interpreting image encoded in operation 501 into a single program transport stream. In addition, the digital broadcast headend system may incorporate information related to the sign language interpreting image into image data resulting from the multiplexing.

In operation 503, the digital broadcast headend system may transmit, to a broadcast receiver, the image data resulting from the multiplexing of operation 502.

Accordingly, the broadcast receiver may receive, from the digital broadcast headend system, streaming data multiplexed from the broadcast image and the sign language interpreting image. In addition, the broadcast receiver may verify information related to the sign language interpreting image, in relation to the multiplexed streaming data.

The digital broadcast headend system may incorporate information indicating whether a sign language interpreting image is present, and a sign language descriptor into the image data resulting from the multiplexing, as the information related to the sign language interpreting image. In particular, the sign language descriptor may include identification information of a packet in which the sign language interpreting image is included. In addition, the information indicating whether a sign language interpreting image is present, and the sign language descriptor may be present as information inserted in a PMT syntax.

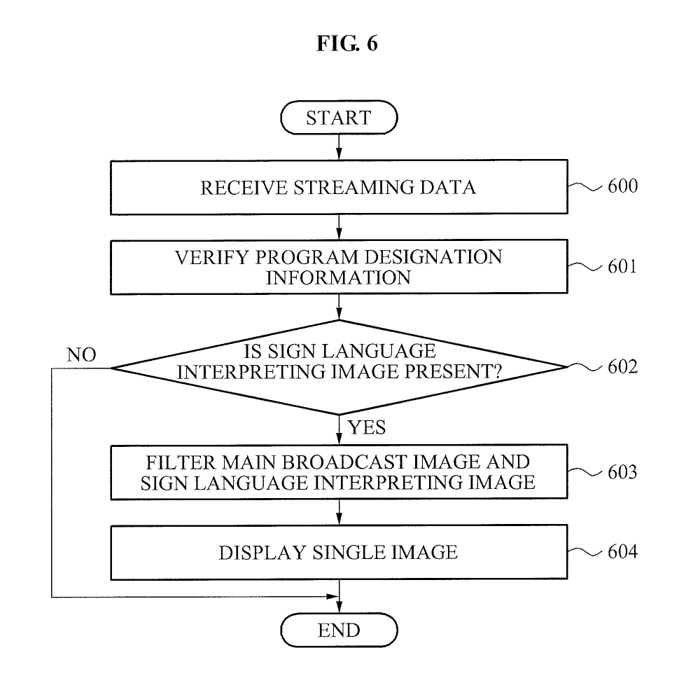

FIG. 6 is a flowchart illustrating an operation of a broadcast receiver in a method of providing the sign language interpreting service according to an embodiment of the present invention.

Referring to FIG. 6, in operation 600, the broadcast receiver may receive streaming data from a digital broadcast headend system. In particular, the broadcast receiver may select a broadcast program based on an input of a user selection, and may receive streaming data of the selected broadcast program from the digital broadcast headend system.

In operation 601, the broadcast receiver may verify program designation information based from the received streaming data. In particular, the broadcast receiver may interpret a PAT syntax and a PMT syntax from the streaming data, and may verify information related to a sign language interpreting image. The broadcast receiver may verify the PMT syntax to obtain information indicating whether a sign language interpreting image is present, and a sign language descriptor, for example, sign language descriptor.

In operation 602, the broadcast receiver may determine whether a sign language interpreting image is present in the streaming data, based on the verified program designation information. In particular, the broadcast receiver may verify the PMT syntax to determine whether a sign language interpreting image is present in the streaming data.

When a sign language interpreting image is present as a result of operation 602, the broadcast receiver may filter a main broadcast image and the sign language interpreting image from the streaming data, respectively, in operation 603. In particular, the broadcast receiver may separate the main broadcast image and the sign language interpreting image from the streaming data, respectively, based on the sign language descriptor.

In operation 640, the broadcast receiver may compose the filtered main broadcast image and the filtered sign language interpreting image into a single image, and may display the single image. In particular, the broadcast receiver may change a broadcasting mode from a sign language inactive mode to a sign language active mode, in order to compose the filtered main broadcast image and the filtered sign language interpreting image into the single image, and to display the single image. When a sign language interpreting image to be displayed is absent, the broadcast receiver may change the broadcast mode to the sign language inactive mode.

Further, the broadcast receiver may display the filtered main broadcast image on a screen, and may display the filtered sign language interpreting image in the displayed main broadcast image. In addition, the broadcast receiver may change a size and a location of the sign language interpreting image to be displayed, based on display setting information or an input of a user selection.

When a sign language interpreting image is absent as a result of operation 602, the broadcast receiver may display the streaming data using a general broadcast image. In this instance, the broadcast receiver may change the broadcast mode to the sign language inactive mode.

The method of providing the sign language broadcasting service may be implemented by a sign language broadcasting service system including the digital broadcast headend system and the broadcast receiver.

The sign language broadcasting service system may include the digital broadcast headend system to encode each of a broadcast image of a broadcast program and a sign language interpreting image in a form of a transport stream, to multiplex the encoded broadcast image and the encoded sign language interpreting image into a single program transport stream, and to transmit image data resulting from the multiplexing to a broadcast receiver, and the broadcast receiver to receive streaming data from the digital broadcast headend system, to determine whether a sign language interpreting image is present in the streaming data, based on program designation information verified from the received streaming data, to filter a main broadcast image and the sign language interpreting image from the streaming data, respectively, when the sign language interpreting image is present as a result of the determining, and to compose the filtered main broadcast image and the filtered sign language interpreting image into a single image, and display the single image.

The above-described exemplary embodiments of the present invention may be recorded in computer-readable media including program instructions to implement various operations embodied by a computer. The media may also include, alone or in combination with the program instructions, data files, data structures, and the like.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of providing a sign language broadcasting service, the method comprising:
encoding a broadcast image of a broadcast program in a form of a transport stream;
encoding a sign language interpreting image in a form of a transport stream;
multiplexing the encoded broadcast image and the encoded sign language interpreting image into a single program transport stream; and
transmitting image data resulting from the multiplexing to a broadcast receiver.

2. The method of claim 1, wherein the broadcast image and the sign language interpreting image are encoded in a moving picture experts group (MPEG) transport stream.

3. The method of claim 1, further comprising:
incorporating information related to the sign language interpreting image in the image data resulting from the multiplexing.

4. The method of claim 3, wherein the incorporating comprises incorporating information indicating whether a sign language interpreting image is present, and a sign language descriptor in the image data resulting from the multiplexing.

5. The method of claim 4, wherein the sign language descriptor comprises identification information of a packet in which a sign language image is included.

6. The method of claim 4, wherein the information indicating whether a sign language interpreting image is present, and the sign language descriptor are present as information inserted in a program map table (PMT) syntax.

7. A method of receiving a sign language broadcasting service, the method comprising:
receiving streaming data from a digital broadcast headend system;
verifying program designation information from the received streaming data;
determining whether a sign language interpreting image is present in the streaming data, based on the verified program designation information;
filtering a main broadcast image and a sign language interpreting image from the streaming data, respectively, when the sign language interpreting image is present as a result of the determining; and
composing the filtered main broadcast image and the filtered sign language interpreting image into a single image, and displaying the single image.

8. The method of claim 7, wherein the determining comprises:
interpreting a program allocation table (PAT) syntax and a program map table (PMT) syntax from the streaming data, and obtaining information about a sign language interpreting image based on a result of the interpreting; and
determining whether a sign language interpreting image is present in the streaming data, based on the obtained information about the sign language interpreting image.

9. The method of claim 8, wherein the information related to the sign language interpreting image comprises information indicating whether the sign language interpreting image is present, and a sign language descriptor.

10. A sign language broadcast service system, comprising:
a digital broadcast headend system to encode each of a broadcast image of a broadcast program and a sign language interpreting image in a form of a transport stream, to multiplex the encoded broadcast image and the encoded sign language interpreting image into a single program transport stream, and to transmit image data resulting from the multiplexing to a broadcast receiver; and
a broadcast receiver to receive streaming data from the digital broadcast headend system, to determine whether a sign language interpreting image is present in the streaming data, based on program designation information verified from the received streaming data, to filter a main broadcast image and the sign language interpreting image from the streaming data, respectively, when the sign language interpreting image is present as a result of the determining, and to compose the filtered main broadcast image and the filtered sign language interpreting image into a single image, and display the single image.
